(19) United States
(12) Patent Application Publication
(10) Pub. No.: US 2009/0190077 A1
(43) Pub. Date: Jul. 30, 2009

(54) Bistable SmA liquid-crystal display

(75) Inventor: WEI LEE, Tao-Yuan (TW)

Correspondence Address: WPAT, PC, Suite 200, 1940 Duke St., Alexandria, VA, 22314, US

(73) Assignee: Chung Yuan Christian University, Tao-Yuan (TW)

(21) Appl. No.: 12/359,109

(22) Filed: Jan. 23, 2009

Related U.S. Application Data
(63) Continuation-in-part of application No. 11/963,491, filed on Dec. 21, 2007.

(51) Int. Cl. G02F 1/1337; C09K 19/04; G02F 1/1343

(52) U.S. Cl. 349/130; 349/184; 349/139

(57) ABSTRACT

A bistable SmA liquid-crystal display is disclosed. A striped electrode pattern is coated on one of two substrates and an ITO film is coated on the other to switch the director of SmA liquid crystals between the homeotropic and planar states by applying a vertical electric field across the cell thickness and a horizontal electric field via the striped electrodes, respectively.

### BACKGROUND OF THE INVENTION

1. Field of the Invention

The present invention generally relates to a bistable liquid-crystal display, and more particularly, to a smectic A (SmA) liquid-crystal display.

2. Description of the Prior Art

In liquid-crystal display (LCD) devices, bistable LCDs have a unique optical characteristic in which images can be kept under the circumstance that no external electric field is applied. As a result, the bistable LCDs eliminate unnecessary power consumption and provide more flexible applications.

One type of bistable LCD is a smectic A (SmA) LCD. By laser addressing or electric addressing, SmA LCD can switch from a transparent state with homeotropic alignment into an opaque light-scattered state with a focal conic (FC) texture, thereby displaying a light or a dark state. Compared to a completely dark state, the scattering state will have a poorer contrast level of about 200:1. Additionally, comparing to other types of LCDs, SmA LCDs take longer to switch from the homeotropic alignment to the FC texture.

Thus, there is a need for a SmA LCD with a better design to enhance contrast and response time, thus increasing its potential in soft display applications such as electronic papers.

### SUMMARY OF THE INVENTION

In view of the prior art and the needs of the related industries, the present invention provides that solves the abovementioned shortcomings of the conventional.

One objective of the present invention is to provide a SmA LCD, including: a SmA liquid crystal layer including a plurality of SmA liquid crystals; two substrates including first and second substrates, the SmA liquid crystal layer being disposed between the first and second substrates; a first electrode layer disposed on the first substrate with two sets of electrodes, wherein the two sets of electrodes provide a horizontal electric field parallel to the substrates when oppositely charged; and a second electrode layer disposed on the second substrate, wherein the first electrode layer and the second electrode layer provide a vertical electrical field perpendicular to the substrates when oppositely charged.

In one embodiment of the present invention, the abovementioned second electrode layer may also include two sets of electrodes providing a horizontal electric field parallel to the substrates when oppositely charged. In one embodiment of the present invention, each of the two sets of electrodes may include a plurality of extension electrodes, extension electrodes of the different sets being interlaced with one another.

In one embodiment of the present invention, two neighboring extension electrodes of the same set of electrodes may be interlaced with an extension electrode of the other set.

In one embodiment of the present invention, the SmA LCD further includes a pair of crossed polarizers sandwiching the SmA liquid crystals, such that light may pass sequentially through one of the crossed polarizers, the SmA liquid-crystal layer and the other one of the crossed polarizers.

In one embodiment of the present invention, the SmA LCD further includes an alignment layer on at least one substrate. The alignment layer can be made of polyimide resin, Nylon resin or Teflon resin.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a schematic diagram illustrating the chemical structure and phase transition sequence of a SmA liquid crystal W559;

FIG. 2 is a schematic diagram depicting a striped electrode; and

FIG. 3 is a schematic cross-sectional diagram showing a SmA LCD adopting a striped electrode.

### DETAILED DESCRIPTION OF THE PREFERRED EMBODIMENTS

The present invention is directed to smectic A (SmA) liquid crystal displays (LCDs). Detailed steps and constituents are given below to assist in the understanding the present invention. Obviously, the implementations of the present invention are not limited to the specific details known by those skilled in the art of SmA LCDs. On the other hand, well-known steps or constituents are not described in details in order not to unnecessarily limit the present invention. Detailed embodiments of the present invention will be provided as follow. However, apart from these detailed descriptions, the present invention may be generally applied to other embodiments, and the scope of the present invention is thus limited only by the appended claims.

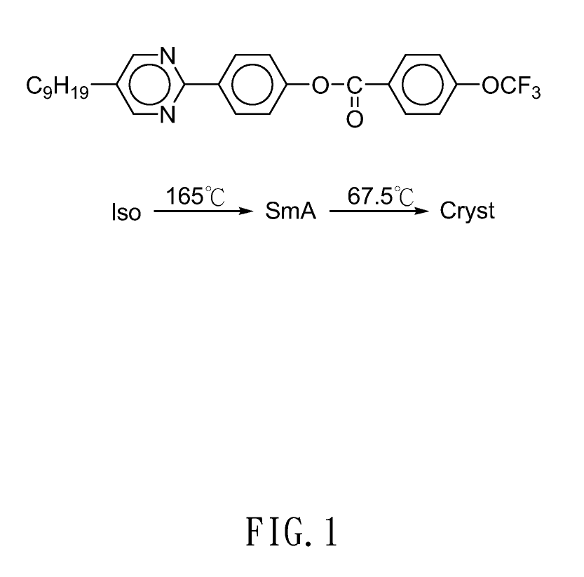

The present invention provides a SmA LCD, in which an electrode between two substrates of a traditional liquid-crystal cell is arranged in a grid (e.g. an interlaced finger-shaped electrode) to provide voltages in two different directions, one being vertical to the upper and lower substrates, and the other being horizontal to the substrates, thus the director of the liquid crystal molecules can be switched between two states. FIG. 1 illustratively shows the chemical structure and phase transition sequence of a SmA liquid crystal W 559. Additionally, S2A liquid crystal available from Merck Co. is also suitable for the present invention. It can be appreciated by those with ordinary skill in the art that other types of SmA liquid crystals can be used in implementation of the present invention; the SmA liquid crystal described and shown herein is non-limiting and served as one of various embodiments of the present invention.

Accordingly, each of the two substrates of the liquid crystal cell are provided with an electrode layer thereon, respectively. The electrode layer on at least one of the substrates includes two sets of striped electrodes with different charges. There can be only one electrode having two sets of striped electrodes with different charges or two electrodes each having two sets of striped electrodes with different charges. Each set of the striped electrodes further includes a plurality of extension electrodes, where the extension electrodes of different set interlaced with each other. For example, an extension electrode from one set of the striped electrodes is arranged between two neighboring extension electrodes from another set. Alternatively, two neighboring extension electrodes may sandwich one extension electrode from the same set and one extension electrode from another set. It can be appreciated by those with ordinary skill in the art that other interlacing arrangements are possible; the examples described and shown herein are non-limiting and served only as a few of various embodiments of the present invention.

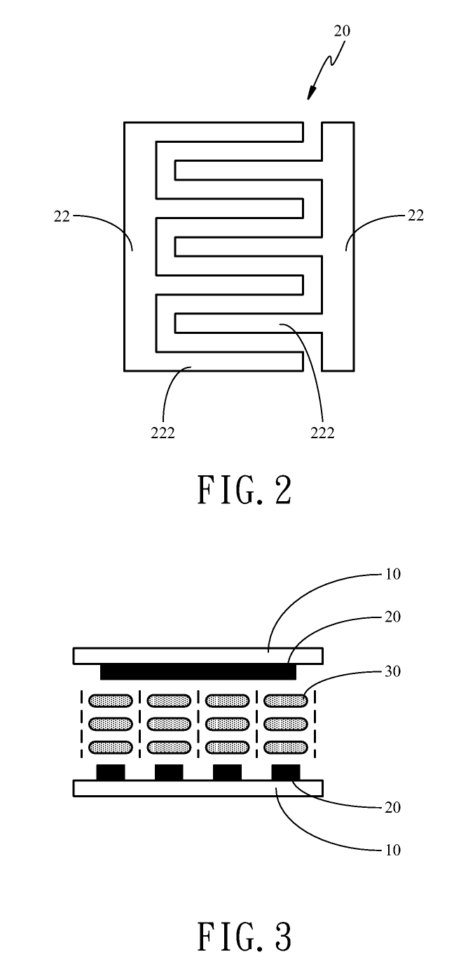

As shown in FIG. 3, a SmA LCD of a preferred embodiment of the present invention is shown, which includes two substrates 10, two electrode layers 20 and a SmA liquid-crystal layer 30. The SmA liquid-crystal layer 30 includes a plurality of SmA liquid crystals. The two electrode layers 20 can be used to provide a vertical electric field, such that it drives the director axes of the SmA liquid crystals of the SmA liquid crystal layer 30 to be homeotropically aligned. One of the electrodes 20 includes two set of striped electrodes 22 in FIG. 2. Each set of striped electrodes 22 includes a plurality of extension electrodes 222, where extension electrodes of different sets are interlaced with one another. Therefore, the striped electrodes of the different sets can be charged differently to provide a planar electric field, which drives the director axes of the SmA liquid crystals of the SmA liquid crystal layer 30 to be planarly aligned. In one embodiment of the present invention, each of the two electrode layers 20 has two sets of striped electrodes 22.

The electrode layers 20 can be indium tin oxide (ITO). The substrates can be made of a glass material. Both form a transparent ITO conductive glass. Moreover, the substrates can be made of a flexible (e.g. plastic) material, such that the SmA LCD may be a soft display. It can be readily appreciated by those with ordinary skills in the art that the electrode layers 20 and the substrates can be made of other materials; the examples described and shown herein are non-limiting and served only as a few of various embodiments of the present invention.

In other words, the director of the liquid crystal molecules can be aligned homeotropically or planarly by applying a vertical or horizontal electric field. For example, by applying a voltage across the liquid crystal cell, the director can be switched from planar alignment (light) to homeotropic alignment (dark). As such, the SmA LCD can be used to display a completely dark state, even without an applied voltage. Similarly, by applying a horizontal voltage generated between the striped electrodes 22, the director of the liquid crystal molecules can be switched to planar alignment (light) accordingly. As such, the SmA LCD can now be used to display a completely light state, even without an applied voltage.

Additionally, the preferred embodiment of the present invention may further include a pair of crossed polarizers (not shown). Light passes through the first polarizer and the SmA liquid-crystal layer 30 to the second polarizer with a perpendicular polarization. Compared to a traditional SmA LCD, the present embodiment may significantly improve the contrast level from about 200:1 to about 2500:1.

Moreover, the present embodiment may further include an alignment layer coated onto each of the inner sides of the upper and lower substrates. After a rubbing process, the surface of the alignment layers is formed with grooves oriented in a certain direction due to the rubbing, the SmA liquid crystals anchored on the alignment layer may be oriented and thus aligned as a result of intermolecular forces. Thus, the liquid crystal molecules can be oriented in certain directions and certain inclined angles to facilitate displaying. Since polyimide resin (PI), Nylon resin and Teflon resin have characteristics such as high transmittancy, uniform liquid crystal alignment, high charge retaining rate, high heat resistance and good chemically stability, they are suitable for the alignment layer. It can be readily appreciated by those with ordinary skills in the art that other types of materials can be used as the alignment layer; the examples described and shown herein are non-limiting and served only as a few of various embodiments of the present invention.

In summary, the SmA LCD of the present invention cay rapidly switch between light and dark states by applying a horizontal or vertical electric field, respectively, and has good bistability. Since the SmA LCD has fast response, the vertical and horizontal electric fields can be interspersed at a certain frequency to provide gray-scale effect. Different levels of gray scale can be obtained by altering the frequency between light and dark states.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A smectic A (SmA) liquid crystal display (LCD), including:
a SmA liquid crystal layer including a plurality of SmA liquid crystals;
two substrates including first and second substrates, the SmA liquid crystal layer being disposed between the first and second substrates;
a first electrode layer disposed on the first substrate with two sets of electrodes, wherein the two sets of electrodes provide a horizontal electric field parallel to the substrates when oppositely charged; and
a second electrode layer disposed on the second substrate, wherein the first electrode layer and the second electrode layer provide a vertical electrical field perpendicular to the substrates when oppositely charged;
wherein the director of SmA liquid crystal between the homeotropic and planar states can be switched by said vertical electric field and said horizontal electric field, respectively.

2. A SmA LCD of claim 1, wherein each of the two sets of electrodes includes a plurality of extension electrodes, extension electrodes of the different sets being interlaced with one another.

3. A SmA LCD of claim 2, wherein two neighboring extension electrodes of the same set of electrodes are interlaced with an extension electrode of the other set.

4. A SmA LCD of claim 1, further including a pair of crossed polarizers, light passing through one of the crossed polarizers, the SmA liquid-crystal layer and the other one of the crossed polarizers.

5. A SmA LCD of claim 1, further including an alignment layer on at least one substrate.

6. A SmA LCD of claim 5, wherein the alignment layer is made of polyimide resin, Teflon resin or Nylon resin.

7. A SmA LCD of claim 1, wherein the first and second electrode layers includes indium tin oxide (ITO).

8. A SmA LCD of claim 1, wherein the two substrates are made of glass or flexible materials.

9. A SmA LCD of claim 1, wherein the horizontal electric field allows the directors of the SmA liquid crystals to be planarly aligned.

10. A SmA LCD of claim 1, wherein the vertical electric field allows the directors of the SmA liquid crystals to be homeotropically aligned.

11. A SmA LCD of claim 1, wherein the second electrode layer also includes two sets of electrodes providing a horizontal electric field parallel to the substrates when oppositely charged.

12. A SmA LCD of claim 1, wherein the vertical and horizontal electric fields can be interspersed at a frequency, and the gray scale can be achieved by regulating the frequency.

13. A SmA LCD of claim 12, wherein the frequency can be altered between light and dark states to obtain different levels of gray scale.
